(19) United States
(12) Patent Application Publication
(10) Pub. No.: US 2023/0045341 A1
(43) Pub. Date: Feb. 9, 2023

(54) DEVICE FOR LASER-BASED HEAT TREATMENT OF A COATING DEPOSITED ON A SUBSTRATE, AND CORRESPONDING SUBSTRATE

(71) Applicant: SAINT-GOBAIN GLASS FRANCE, COURBEVOIE (FR)

(72) Inventors: Jean-Baptiste LAUDEREAU, PARIS (FR); Daniele COSTANTINI, PARIS (FR)

(21) Appl. No.: 17/787,112

(22) PCT Filed: Dec. 18, 2020
(86) PCT No.: PCT/FR2020/052566

§ 371 Date: Jun. 17, 2022

(30) Foreign Application Priority Data
Dec. 20, 2019 (FR) 1915196

(51) Int. Cl. B23K 26/362; B23K 26/067; B23K 26/082; B23K 26/08; C03C 17/06

(52) U.S. Cl. CPC B23K 26/362; B23K 26/0676; B23K 26/0821; B23K 26/0846; C03C 17/06; B23K 2101/34

(57) ABSTRACT

A device for heat treating a coating deposited on a substrate includes a treatment module opposite which the substrate runs, the treatment module including a laser source generating a laser beam of energy, a splitter module to split the beam into a multitude of secondary beams, having an energy En to treat the coating, that have the form of a point, a scanner allowing each secondary beam to be displaced in the running direction according to a first amplitude and first velocity and/or in a direction orthogonal to the running direction according to second amplitude and second velocity; and a displacement system to create, in operation, a relative displacement movement between the substrate and the or each treatment module.

The present invention relates to the field of substrate treatment devices.

### PRIOR ART

Currently, it is known practice to use lasers in the context of glass making processes in order to do a coating heat treatment. In this case, one or more laser beams are used to form a line that allows a substrate to be heat treated. It is also known practice to use a laser to do the substrate etching, notably to do the marking. In this case, a laser beam is focused on the substrate to etch it. This etching can be used in the context of identification.

There is also another application for laser etching in the field of glass substrates. This application relates to the etching of metallic coatings for electromagnetic signal transmission applications, for example those used in telecommunications. In fact, the coatings comprising an overlay of notably metallic layer act as shields preventing the good circulation of the radiofrequency signals. Now, these radiofrequency signals have become very widely used because they allow a high quantity of information, such as entertainment, but also useful contents such as navigation or telecommunications, to be transported.

It is therefore becoming necessary to ensure that the glass substrates do not form an obstacle to data transmission via radiofrequency signals. For that, one solution consists in reducing the shield effect of the metallic coatings. This reduction is obtained by laser etching. This laser etching consists in locally etching the coating to reduce the shielding effect.

Now, these days, it is necessary to find a method that makes it possible to treat a coated substrate at an industrial rate.

### SUMMARY OF THE INVENTION

The present invention therefore proposes resolving these drawbacks by providing a heat treatment device that makes it possible to treat a significant substrate surface for an industrial use.

To this end, the invention relates to a device for heat treating a coating deposited on a substrate comprising: - at least one treatment module opposite which the substrate can run, said treatment module comprising at least one laser source generating a laser beam of energy E, a splitter module allowing the beam to be split into a multitude of secondary beams having an energy En making it possible to treat the coating having the form of a point, scanning means allowing each secondary beam to be moved in the running direction according to an amplitude and a velocity and/or in a direction orthogonal to the running direction according to an amplitude and a velocity;
movement means capable of creating, in operation, a relative displacement movement between the substrate and the or each treatment module;
characterized in that the heat treatment device is arranged to, with a velocity of the displacement means of at least 3 m/min and a velocity of the scanning means in the running direction and/or the direction orthogonal to the running direction of at least 30 m/min, treat the coating in the form of a number of lines equal to the ratio between the energy E of the beam and the energy En allowing the coating to be treated by a secondary beam, in at least the running direction or a direction orthogonal to the running direction, and over a surface of at least 10 m²/min.

According to one example, the heat treatment device comprises at least one etching module for etching in the running direction and at least one etching module for etching in the direction orthogonal to the running direction.

According to one example, at least one splitter module comprises at least one diffractive optic.

According to one example, the splitter module comprises at least one prism.

According to one example, the scanning means comprise at least one scanning element comprising at least optical block.

According to one example, the optical block comprises at least one rotary mirror or at least one polygonal wheel.

According to one example, each optical block is used for the displacement of a secondary beam.

According to one example, each optical block is used for the displacement of at least two secondary beams.

According to one example, the scanning means comprise a plurality of scanning elements.

According to one example, the scanning means allow each secondary beam to be displaced on the surface of the substrate, in the running direction and/or the direction orthogonal to the running direction, at a velocity greater than 1.5 m/s, preferentially greater than 10 m/s, more preferentially greater than 20 m/s.

According to one example, the scanning means allow each secondary beam to be displaced on the surface of the substrate, in the running direction and/or the direction orthogonal to the running direction, at a velocity less than 6000 m/s.

According to one example, the ratio of the velocities between the velocity of displacement of the substrate and the velocity in the running direction and/or the direction orthogonal to the running direction is greater than 10, preferentially greater than 50.

According to one example, the etching perimeter of each scanning element has an amplitude a1 greater than 100 mm, preferentially greater than 150 mm.

According to one example, the etching perimeter of each scanning element has an amplitude a2 greater than 100 mm, preferentially greater than 150 mm.

According to one example, the device is capable of treating a zone of width greater than 1 m, preferably 1.5 m, and even more preferably 3 m.

The invention also relates to a substrate on which a coating is deposited, characterized in that said coating is treated by the device according to the invention.

According to one example, said substrate is glass.

According to one example, said substrate is a polymer.

According to one example, the coating is metallic.

### DESCRIPTION OF THE FIGURES

Other particular features and advantages will clearly emerge from the description which is given thereof hereinbelow, in an indicative and nonlimiting manner, with reference to the attached drawings, in which:

FIGS. 1a and 1b are schematic representations of a treatment device according to a first embodiment of the invention;

FIG. 2 is a schematic representation of a treatment device according to a second embodiment of the invention;

FIG. 3 is a schematic representation of a variant of the treatment device;

FIG. 4 is a schematic representation of a treatment device according to a third embodiment of the invention;

FIG. 5 to 7 are diagrams relating to the number of lines that can be produced.

### DETAILED DESCRIPTION OF THE INVENTION

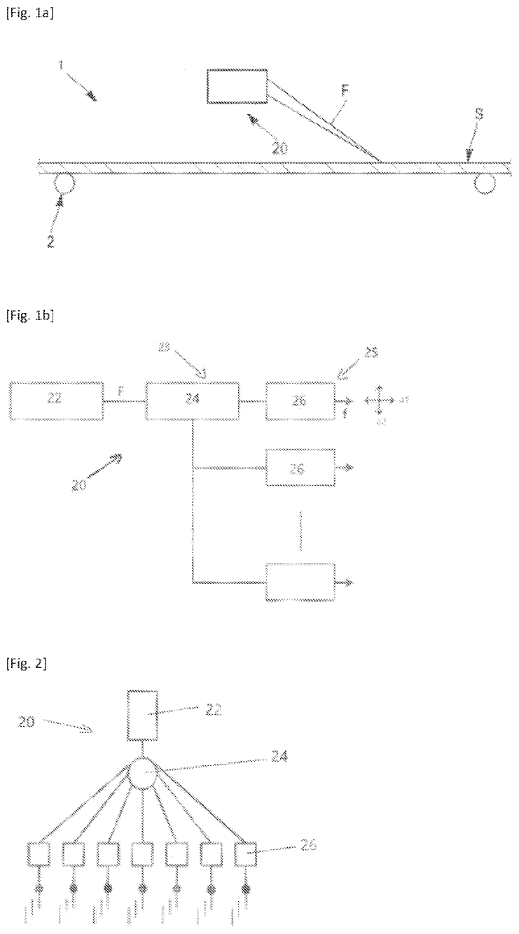

A laser treatment device 1 comprises displacement means 2 allowing a substrate S to be conveyed, as can be seen in FIG. 1a. This substrate S is a substrate of glass or polymer type, transparent or not, on which a coating is deposited. This coating may or may not be metallic. This substrate is, preferably, a substrate of large size, at least 1.5 m wide 1 and 2 m long L, preferably 3 m wide and 6 m long. This coating comprises at least one layer of a metallic material.

The velocity of displacement V3 is at least 3 m/min, preferably at least 5 m/min, even 10 m/min.

The laser treatment device further comprises a treatment unit 20 for treating the surface of the coating. Surface treatment is understood to mean material modification methods affecting depths less than 10% of the thickness of the treated product. Non-exhaustively, surface treatment can comprise, for example, ablation, annealing, marking, texturing or a chemical reaction.

This treatment unit is used to locally etch the coating over a zone Z of width 11 and of length L1. Ideally, the width 11 is equal to the width of the substrate and the length L1 is equal to the length of the substrate.

Shrewdly according to the invention, the treatment unit is capable of treating the zone Z in one time.

In a first embodiment visible in FIG. 1b, the treatment unit 20 comprises a laser source 22 supplying a primary laser beam F of energy E. The beam F has the form of a point, that is to say that its surface is less than 31.000 μm² and/or its form has cylindrical symmetry. This primary laser beam is directed toward a splitter module 23. This splitter module 23 is used to split this primary beam F into a multitude of secondary beams f. This splitter module 23 comprises at least one optical splitter 24 provided with at least one beam splitter element (for example, in a nonlimiting manner, a prism or semireflecting mirror or a refractive element) to split the primary beam F into at least two parts. The secondary beams f are then sent into scanning means 25, the scanning means 25 comprise at least one scanning element 26.

Each secondary beam f is directed toward a scanning element 26. This scanning element 26 is used in order to control the displacement of the secondary beam. Indeed, the scanning element 26 is the element which makes it possible to direct the laser beam f to apply the etching. This beam f used for the etching has the form of a point. Form of a point is understood to mean that the beam F has cylindrical symmetry. The scanning element 26 comprises, for example and in a nonlimiting manner, at least one optical block 27 into which a secondary beam f can enter.

The optical block 27 used comprises at least one mobile optical part (for example, in a nonlimiting manner, a rotating mirror or a polygonal wheel or a translational plate) that makes it possible to spatially sweep the laser point of the secondary beam over the surface of the running substrate. For example, a polygonal wheel allows a scanning velocity of approximately 6000 m/s.

The optical block 27 used also comprises at least one lens used to focus the beam at the output of the optical block 27. The optical block 27 comprises, alternatively, several lenses or other optical parts (for example and in a nonlimiting manner, mirrors or beam-forming elements).

According to the invention, the optical block 27 allows the output beam from the optical block to be displaced according to a certain perimeter. This limitation stems for example from the scanning amplitude of the mobile parts or the aperture of the lens.

In a first embodiment of the invention, the focusing point of the secondary beam f at the output of said optical block 27 can be displaced by an amplitude a1 in the running direction at a velocity V1. This amplitude a1 has a value greater than 100 mm, preferentially greater than 150 mm.

In a second embodiment of the invention, the focusing point of the secondary beam f at the output of said optical block 27 can be displaced within a perimeter of amplitude a2 in the direction at right angles to the running direction and with a velocity V2. This amplitude a2 has a value greater than 100 mm, preferentially greater than 150 mm.

In a third embodiment that can be seen in FIG. 2, the scanning element 26 can, in addition, scan according to two axes: an axis parallel to the running direction and an axis orthogonal to the running direction. In this case, the secondary beam can be displaced within a perimeter of amplitude a1 in the running direction of the substrate with a velocity V1 and within a perimeter of amplitude a2 in the direction at right angles to the running direction of the substrate with a velocity V2.

This third embodiment advantageously makes it possible to have a secondary beam f at the output of the optical block 27 used to etch several parallel lines. The velocities V1 and V2 can be identical or not.

Consequently, the scanning element 26 makes it possible to etch a pattern M comprising a number N of beams. The number N of beams depends, among other things, on the scanning amplitude a2 and the spacing e between two desired parallel etchings, i.e. N=a2/e.

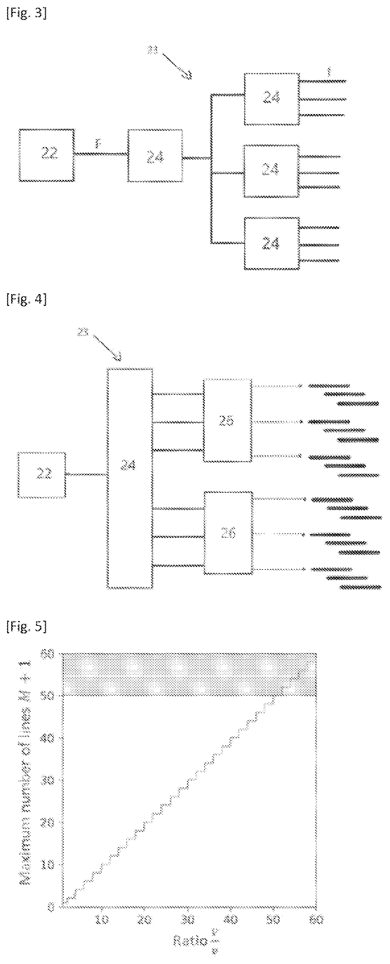

In an alternative of these three embodiments that can be seen in FIG. 3, the splitter module 23 comprises a plurality of cascade-mounted identical or standard optical splitters 24. For example, to extract nine secondary beams f, it may be useful to replace one optical splitter 24 allowing the creation of nine secondary beams f from one primary beam with a two-stage system comprising, in the first stage, a standard splitter 24 making it possible to create three so-called intermediate beams from one primary beam F, each intermediate beam entering into a standard splitter 24 making it possible to create three secondary beams from one intermediate beam, i.e., in total, nine secondary beams. This alternative advantageously makes it possible to use replaceable standard parts as required.

In a third embodiment that can be seen in FIG. 4, the splitter module 23 generates a plurality of secondary beams f, these secondary beams f being grouped together in groups of at least two to enter into a scanning element 26. In fact, this third embodiment is characterized by the use of scanning elements 26 capable of managing at least two incoming beams. For that, said scanning element 26 comprises at least two optical blocks 27, each optical block 27 being able to displace the secondary beams f, at least in the running direction within a perimeter of amplitude a1.

Preferentially, each optical block 27 can also displace the secondary beams f in a direction orthogonal to the running direction within a perimeter of amplitude a2.

This preference makes it possible to create a pattern M comprising a number n of lines and therefore increase the number of lines etched.

Thus, each secondary beam f from the splitter module 23 enters into a scanning element 26 and, more particularly, into an optical block 27 of said scanning element 26.

This third embodiment advantageously makes it possible to reduce the number of scanning elements 26.

In another embodiment, the plurality of secondary beams can enter into a scanning element 26, said scanning element 26 having only a single optical block 27 capable of scanning a plurality of secondary beams f simultaneously. As a nonlimiting example, this optical block 27 could have mobile optical elements that are wide enough to pick up all the secondary beams f entering into said optical block 27 in order to displace them at the same time. Still as a nonlimiting example, said optical block 27 could benefit from blocking means making it possible to select the secondary beam to be displaced. Preferentially, said optical block 27 can also displace the secondary beams f in a direction orthogonal to the running direction within a perimeter of amplitude a2. This preference makes it possible to create a pattern M comprising a number n of lines and therefore increase the number of lines etched.

This alternative embodiment advantageously makes it possible to reduce the number of optical blocks 27.

The treatment device 1 according to the invention therefore makes it possible to etch a plurality of parallel lines n on the coating of a substrate S. Now, a second treatment device 1 according to the invention can be used. This second treatment device 1 according to the invention is arranged to etch parallel lines but in a direction other than the running direction. Preferentially, the lines etched by the second treatment device 1 according to the invention are orthogonal to the running direction. This arrangement makes it possible to produce a grid pattern.

It is also possible to envisage each treatment device 1 comprising several treatment units 20 arranged in parallel to treat the substrate in one direction: the running direction and/or a direction orthogonal to the running direction.

While the architecture used for the treatment unit 20 makes it possible to define the number of lines that can be etched, there are other parameters on which to act to increase the number of lines that can be etched.

In fact, for the embodiments in which each scanning element makes it possible to etch a single line, the number N of secondary beams to be supplied by the splitter depends on the width 11 of the zone to be treated, on the spacing e between the desired etchings and on the energy En needed for each etching. In effect, each secondary beam f outgoing from an optical block 27 of the scanning element 26 must have sufficient power to succeed at an etching. Thus, the number of beams N that can be produced depends first on the theoretical number Nt of possible beams, that is to say on the energy E supplied by the source, taking into account the various blocks of the device, divided by the energy En needed for the etching for an outgoing secondary beam f. The number of secondary beams f that can be produced depends also on the practical number Np of possible beams which depends on the width 11 of the zone to be treated and on the spacing e, namely, the number of beams is the result of a ratio of width 11 to spacing e between two lines.

Thus, the following formula is obtained:
if Np is greater than Nt, therefore N equals Nt
if Nt is greater than Np, therefore N equals Np.

For the embodiments in which each scanning element 26 makes it possible to etch several lines, other parameters come into play.

In fact, in this particular case, the etching of the zone Z consists in each scanning element 26 being capable of etching a pattern M, containing a number N of lines, preferentially parallel, each line having a length t1 and being spaced apart from another line by a distance t2.

The pattern M is repeated along the length L1 of the zone Z, to form parallel lines, preferentially continuous.

Now, in this case, the length tl of the line, the distance t2 between two lines, the running velocity V3, the amplitude a1, a2 of the scanning element 26, the scanning velocity V1, V2 and the energy E of the source are parameters to be taken into account.

In fact, each of these parameters is useful for determining the maximum number of lines that can be etched in a pattern M and these parameters are linked to one another.

Of these parameters, the distance t2 between two lines, the amplitude a1, a2 of the scanning element 26 and the energy E of the source are parameters that are fixed (amplitude, energy of the source) or set (distance t2).

Consequently, the parameters of running velocity, length tl of the line or scanning velocity V1, V2 are parameters that must be adjusted. More specifically, length t1 of the line and the ratio between the scanning velocity V1, V2 and the running velocity V3 are the parameters to be set.

In fact, the production of the pattern M composed of a number N of preferentially parallel lines entails producing said number N of lines within a time period such that the production of the next pattern M makes it possible to have continuous patterns M.

Now, the time available for the production of the pattern M depends on the running velocity V3 and on the length of the line t1, the substrate S running by a length equal to the length of the line t1 within a time period equal to the length of the line t1 divided by the running velocity.

The production of the pattern M consists in alternating the etching of one line with a displacement of the secondary beam f to reach the starting position of the etching of the next line. These displacements, in addition to the lines tl to be etched, increase the distance to be traveled by the laser beam to produce said pattern.

Thus, with fixed running velocity V3 and scanning velocity or velocities V1, V2, an increase in the length of the line results in an increase in the number N of lines per pattern M inasmuch as the scanning velocity or velocities are greater than the running velocity V3 as can be seen in FIG. 7. This FIG. 7 shows a curve of the number of lines as a function of the length of the line with a curve 1 for a glass substrate 3 m wide and a running velocity of 10 m/min and a curve 2 for a plastic substrate 1.5 m wide and a running velocity of 20 m/min. If the length of the line increases then the distance to be traveled by the beam to etch a line and be displaced to the starting position of the etching of the next line is also likely to increase. If the scanning velocity or velocities V1, V2 are greater than the running velocity V3 of the substrate S, the scanning can then potentially take a sufficient lead on the substrate to etch more lines, within the limit of the amplitude a1 of the perimeter.

For a running velocity V3 and a line length that are fixed, an increase in scanning velocity or velocities V1, V2 leads to an increase in the number N of lines per pattern M. If the scanning velocity or velocities V1, V2 increase, then the device 1 is capable of etching a line more rapidly and of being displaced to the starting position of the etching of the next line more rapidly. A greater number N of lines can be envisaged.

For one or more scanning velocities V1, V2 and a line length that are fixed, an increase in the running speed V3 leads to a reduction in the number N of lines per pattern M. Since the running speed increases, then the time period allotted for the production of the pattern M decreases. Since the scanning velocity or velocities V1, V2 are fixed, then the number N of lines that can be produced decreases.

The idea is thus to have the possibility, with a treatment module 20 configuration, to generate the maximum of lines in order to contain the number of treatment modules 20 of the same configuration to be used. Indeed, in the case of a scanning element 26 which is displaced in two directions, the optical block 27 is used to artificially create more secondary beams f since the secondary beam f entering into said optical block 27 is used to create a multitude of parallel lines. Thus, the greater the velocity of the scanning element 26 with respect to the running speed, the more the scanning element 26 will be able to produce lines within the allotted time.

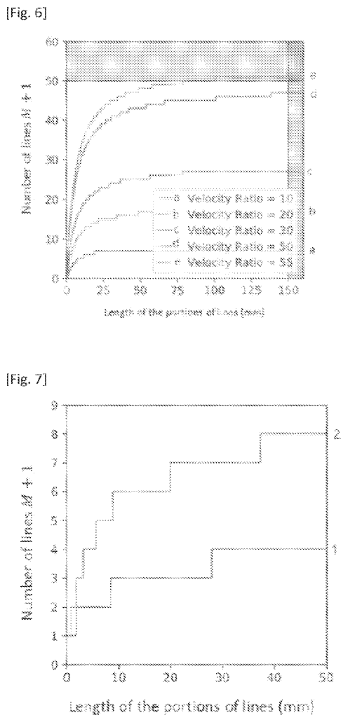

After analysis, two diagrams, that can be seen in FIGS. 5 and 6, are produced on the number of possible lines as a function of the ratio between the scanning velocity (denoted V) and the running velocity (denoted v) (FIG. 5) or as a function of the length of the line etched for different values of this ratio (FIG. 6). These diagrams are produced for a separation between two lines of 3 mm and an amplitude a1, a2 of 150 mm.

These diagrams show that the more the ratio between the scanning velocity and the running velocity increases, the more the number N of lines per pattern M increases. Moreover, it is found that, with the variation of the length tl of the line, there is a limit beyond which there is saturation, that is to say that it is no longer possible to increase the number of lines.

In an exemplary embodiment of the invention, the scanning means are such that the scanning velocity lies between 1.5 and 30 m/s, that the length of the line varies between 10 and 50 mm and that the ratio between the scanning velocity and the running velocity is at least 10, preferably 20 and even more preferably 50. That makes it possible to have a treatment device which treats between 3 and 10 m² per minute.

In a particular example, with a laser developing an energy of 600 μJ on a coating comprise a stacking provided with silver-based layers on a glass substrate with a width of 3 m running at 10 m/min, the coating requiring an energy of 4 μJ to be etched, it is possible to obtain, for a velocity of displacement of the optical block of 20 m/s over an amplitude a1, a2 of 150 mm, a grid of 3 mm on each side, each optical block into which a laser beam enters being able to generate 8 parallel lines. In this specific case, 7 processing modules 20 will have to be used.

For one and the same coating on a plastic substrate having a width of 1.5 m and running at 20 m/min, the energy necessary for the treatment requires 3 μJ, each optical block into which a laser beam enters being able to generate 4 parallel lines. In this specific case, 4 treatment modules 20 will have to be used.

Obviously, the present invention is not limited to the example illustrated but is open to various variants and modifications which will be apparent to a person skilled in the art.

1. A device for heat treating a coating deposited on a substrate comprising:
at least one treatment module opposite which the substrate is movable, said treatment module comprising at least one laser source generating a laser beam of energy E, a splitter module adapted to split the laser beam into a multitude of secondary beams having an energy En, to treat the coating, that has the form of a point, a scanning system allowing each secondary beam to be displaced in a running direction according to a first amplitude and a first velocity and/or in a direction orthogonal to the running direction according to a second amplitude and a second velocity;
a displacement system adapted to create, in operation, a relative displacement movement between the substrate and each treatment module; wherein the device is arranged to, with a velocity of the displacement system of at least 3 m/min and a velocity of the scanning system in the running direction and/or the direction orthogonal to the running direction of at least 30 m/min, treat the coating in the form of a number of lines equal to a ratio between the energy of the Laser beam and an energy (En) that makes it possible to treat the coating by a secondary beam, in at least the running direction or the direction orthogonal to the running direction, and over a surface of at least 10 m²/min.

2. The device as claimed claim 1, further comprising at least one etching module for etching in the running direction and at least one etching module for etching in the direction orthogonal to the running direction.

3. The device as claimed in claim 1, wherein at least one splitter module comprises at least one diffractive optic.

4. The device as claimed in claim 1, wherein the splitter module comprises at least one prism.

5. The device as claimed in claim 1, wherein the scanning system comprises at least one scanning element comprising at least optical block.

6. The device as claimed in claim 5, wherein the optical block comprises at least one rotary mirror or at least one polygonal wheel.

7. The device as claimed in claim 5, wherein each optical block is used for the displacement of a secondary beam.

8. The device as claimed in claim 5, wherein each optical block is used for the displacement of at least two secondary beams.

9. The device as claimed in claim 5, wherein the scanning system comprises a plurality of scanning elements.

10. The device as claimed in claim 1, wherein the scanning system allows each secondary beam to be displaced on the surface of substrate, in the running direction and/or the direction orthogonal to the running direction, at a velocity greater than 1.5 m/s.

11. The device as claimed in claim 1, wherein the scanning system allows each secondary beam to be displaced on the surface of the substrate, in the running direction and/or the direction orthogonal to the running direction, at a velocity less than 6000 m/s.

12. The device as claimed in claim 1, wherein a ratio of the velocities between the velocity of displacement of the substrate and the first velocity in the running direction and/or the second velocity in the direction orthogonal to the running direction, is greater than 10.

13. The device as claimed in claim 1, wherein an etching perimeter of each scanning element has an amplitude greater than 100 mm.

14. The device as claimed in claim 1, wherein the etching perimeter of each scanning element has an amplitude greater than 100 mm.

15. The device as claimed in claim 1, wherein the device is capable of treating a zone of a width greater than 1 m.

16. A substrate on which a coating is deposited, wherein said coating is treated by the device as claimed in claim 1.

17. The substrate as claimed in claim 16, wherein said substrate is glass.

18. The substrate as claimed in claim 16, wherein said substrate is a polymer.

19. The substrate as claimed in claim 16, wherein the coating is metallic.

20. The device as claimed in claim 10, wherein the velocity is greater than 10 m/s.
